(19) United States
(12) Patent Application Publication
(10) Pub. No.: US 2015/0078248 A1
(43) Pub. Date: Mar. 19, 2015

(54) METHODS FOR SUPPORTING COEXISTENCE OF A MOBILE RELAY AND A FIXED RELAY AND CORRESPONDING APARATUSES

(71) Applicant: Alcatel Lucent, Boulogne Billancourt (FR)

(72) Inventors: Feng Han, Shanghai (CN); Wu Zheng, Shanghai (CN); Kaibin Zhang, Shanghai (CN); Wei Wang, Shanghai (CN)

(73) Assignee: ALCATEL LUCENT, Boulogne Billancourt (FR)

(21) Appl. No.: 14/386,679

(22) PCT Filed: Mar. 6, 2013
(86) PCT No.: PCT/IB2013/000722

§ 371 Date: Sep. 19, 2014

(30) Foreign Application Priority Data
Mar. 19, 2012 (CN) 201210074148.0

(51) Int. Cl. H04B 7/15; H04W 8/02

(52) U.S. Cl. CPC H04B 7/15; H04W 8/02
USPC 370/315

(57) ABSTRACT

The present invention discloses methods for supporting coexistence of a mobile relay and a fixed relay in a wireless communication network, and corresponding apparatuses. A method comprises: receiving, by a base station, a first message from a relay; determining, by the base station, whether the relay is a mobile relay or a fixed relay based on the first message received from the relay; sending, by the base station, a second message to a mobility management entity, the second message comprising information indicating whether the relay is a mobile relay or a fixed relay so that the mobility management entity can select a corresponding service gateway SGW and a corresponding packet data network gateway PGW for the relay. According to the present invention, coexistence of a mobile relay and a fixed relay in a wireless communication network can be realized with a minimal impact on standardization work.

### FIELD OF THE INVENTION

The present invention relates to communications, and more particularly relates to methods for supporting coexistence of a mobile relay and a fixed relay in a wireless communication network, and corresponding apparatuses.

### BACKGROUND OF THE INVENTION

To expand the coverage of a wireless communication network, an effective method is to employ a relay. The relay is generally deployed on the edge of its base station to expand the coverage of the base station, and it has the basic function of the base station, but has a smaller coverage. One base station may be provided with one relay. One base station may also be provided with a plurality of relays. Moreover, one relay may also be provided with one or more relays to thereby form a relay cascade. With the relay cascade, the coverage of the wireless communication network may be further expanded.

At present, relays are all fixed and they do not move.

Users on a high-speed moving transport (such as a high-speed train) also need high quality services. But under current technologies, many challenges are faced. For example, since a user equipment UE on the high-speed train is also moving in high speed, frequent handovers between base stations, between relays, or between a base station and a relay are needed. Moreover, since a large number of UEs (such as thousands of UEs) on the high-speed moving transport need to hand over simultaneously, the handover success rate is very low.

Hence, a relay can be mounted on the high-speed moving transport and it is moving in high speed with the transport, and thus it is hereinafter called as a mobile relay, to perform a group handover between base stations for those UEs on the transport it accesses.

Considering the above circumstance, one may envision that a fixed relay and a mobile relay coexist within the coverage of one base station, where the fixed relay enhances the system throughput and/or coverage, and the mobile relay provides access for the UEs on the high-speed moving transport and performs a group handover between base stations for those UEs.

One such scenario is presented in FIG. 1, where base station 110 has two fixed relays 102 and 104; base station 120 has one fixed relay 106; and on high-speed moving train 130, one mobile relay 108 is mounted. Where the base station 110 has coverage 110-1; the base station 120 has coverage 120-1; and the fixed relays 102, 104 and 106 respectively provide coverage 102-1, 104-1 and 106-1. In addition, the mobile relay 108 provides coverage 108-1 for providing an access service to the UEs on the high-speed moving train 130.

The object of the present invention lies in supporting coexistence of a mobile relay and a fixed relay in a wireless communication network with a minimal impact on standardization work.

### SUMMARY OF THE INVENTION

According to a first aspect of the present invention, there is provided a method for supporting coexistence of a mobile relay and a fixed relay in a wireless communication network, comprising: receiving, by a base station, a first message from a relay; determining, by the base station, whether the relay is a mobile relay or a fixed relay based on the first message received from the relay; sending, by the base station, a second message to a mobility management entity, the second message comprising information indicating whether the relay is a mobile relay or a fixed relay so that the mobility management entity can select a corresponding service gateway SGW and a corresponding packet data network gateway PGW for the relay.

According to a second aspect of the present invention, there is provided a base station for supporting coexistence of a mobile relay and a fixed relay in a wireless communication network, comprising: a first receiving unit configured to receive a first message from a relay; a first determining unit configured to determine whether the relay is a mobile relay or a fixed relay based on the first message received from the relay; a first sending unit configured to send a second message to a mobility management entity, the second message comprising information indicating whether the relay is a mobile relay or a fixed relay so that the mobility management entity can select a corresponding service gateway SGW and a corresponding packet data network gateway PGW for the relay.

According to a third aspect of the present invention, there is provided a method for supporting coexistence of a mobile relay and a fixed relay in a wireless communication network, comprising: sending, by a relay, a first message to a base station that may determine whether the relay is a mobile relay or a fixed relay based on the first message received from the relay.

According to a fourth aspect of the present invention, there is provided a relay for supporting coexistence of a mobile relay and a fixed relay in a wireless communication network, comprising: a first sending unit configured to send a first message to a base station that may determine whether the relay is a mobile relay or a fixed relay based on the first message sent from the first sending unit.

According to a fifth aspect of the present invention, there is provided a method for supporting coexistence of a mobile relay and a fixed relay in a wireless communication network, comprising: receiving, by a mobility management entity, a second message from a base station, the second message comprising information indicating whether a relay is a mobile relay or a fixed relay so that the mobility management entity can select a corresponding service gateway SGW and a corresponding packet data network gateway PGW for the relay; and selecting, by the mobility management entity, a SGW and PGW for the relay based on the second message;

wherein if the relay is a mobile relay, the mobility management entity selects a service gateway SGW and a packet data network gateway PGW that are logically separated from the base station, for the relay; if the relay is a fixed relay, the mobility management entity selects a service gateway SGW and a packet data network gateway PGW that coexist with the base station, for the relay.

According to a sixth aspect of the present invention, there is provided a mobility management entity for supporting coexistence of a mobile relay and a fixed relay in a wireless communication network, comprising: a first receiving unit configured to receive a second message from a base station, the second message comprising information indicating whether a relay is a mobile relay or a fixed relay so that the mobility management entity can select a corresponding service gateway SGW and a corresponding packet data network gateway PGW for the relay; and a selecting unit configured to select a SGW and a PGW for the relay based on the second message;

wherein if the relay is a mobile relay, the mobility management entity selects a service gateway SGW and a packet data network gateway PGW that are logically separated from the base station, for the relay; if the relay is a fixed relay, the mobility management entity selects a service gateway SGW and a packet data network gateway PGW that coexist with the base station, for the relay.

According to the present invention, coexistence of a mobile relay and a fixed relay in a wireless communication network can be realized with a minimal impact on standardization work.

### BRIEF DESCRIPTION OF THE DRAWINGS

Other objects and effects of the present invention will become clearer and easier to understand by making reference to the following description taken in conjunction with the accompanying drawings and along with more comprehensive understanding of the present invention, wherein

FIG. 1 illustrates an envisioned scenario where a fixed relay and a mobile relay coexist in a wireless communication network;

FIG. 2 illustrates a wireless communication system in which embodiments of the present invention can be carried out;

FIG. 3 illustrates a signal flow diagram between respective devices as illustrated in FIG. 2 in phase II;

FIG. 4 illustrates a block diagram of base station 220 for supporting coexistence of a mobile relay and a fixed relay in a wireless communication network according to an embodiment of the present invention;

FIG. 5 illustrates a block diagram of relay 210-1 or 210-2 for supporting coexistence of a mobile relay and a fixed relay in a wireless communication network according to an embodiment of the present invention;

FIG. 6 illustrates a block diagram of a mobility management entity 230-1, 230-2, . . . , or 230-N for supporting coexistence of a mobile relay and a fixed relay in a wireless communication network according to an embodiment of the present invention.

In all of the accompanying drawings, the same reference numbers represent identical, similar or corresponding features or functions.

### DETAILED DESCRIPTION OF EMBODIMENTS

Embodiments of the present invention will be described below in detail by making reference to the accompanying drawings.

The specification framework as well as node functionality to support a fixed relay are much different from the specification framework as well as node functionality to support a mobile relay. The detailed analysis is given as follows.

As for a fixed relay, 3GPP has specified the architecture in TS 36.300 in Rel-10 version, where the functions of a service gateway SGW and packet data network gateway PGW for the fixed relay have been incorporated into donor base station DeNB of the fixed relay.

As for a mobile relay, there are two options for the location of the SGW and PGW.

Option 1: the functions of the SGW and PGW for the mobile relay are also incorporated into DeNB of the mobile relay as similar with the fixed relay.

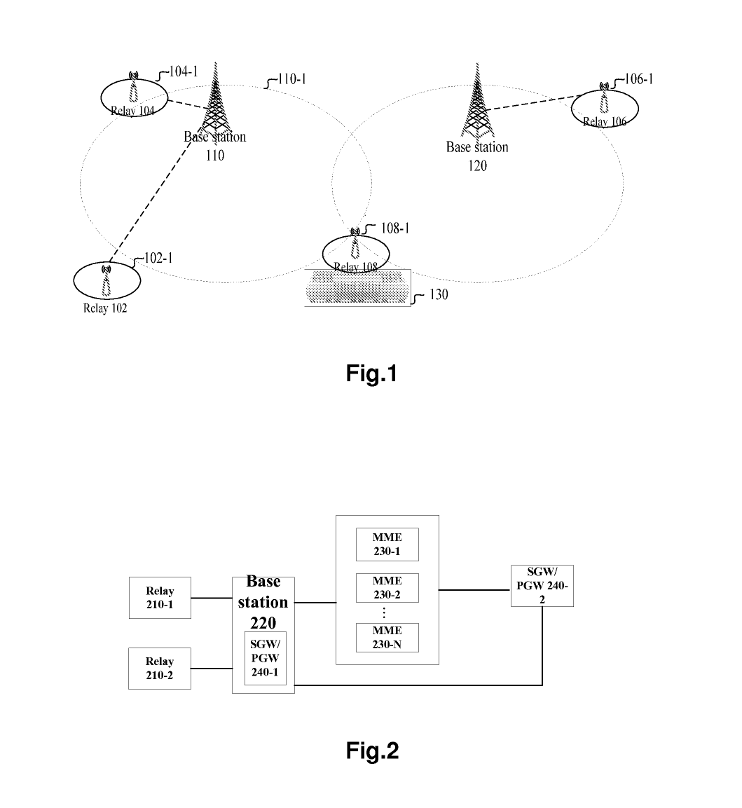

In this option, the DeNB of the mobile relay provides the SGW and PGW functions needed for the operation of the mobile relay. When the mobile relay hands over from source DeNB to target DeNB, e.g., from base station 110 to base station 120 as indicated in FIG. 1, it performs group handover for its UEs.

When the group handover is performed, there are two choices for transfer of the functions of the SGW and PGW for the mobile relay.

1) The functions of the SGW and PGW for the mobile relay are transferred from the base station 110 to the base station 120.

Since current LTE specification has not specified relevant procedure for PGW relocation, this choice requires much specification effort. Furthermore, this operation requires envisaging whether the IP address of the mobile relay is changed or not during the group handover procedure. If the IP address of the mobile relay is changed, the mobile relay has to re-establish the packet data network PDN connection, i.e. to deactivate and reactive the PDN during each group handover procedure, which however will incur service interruption. If the IP address of the mobile relay is not changed and is reserved, this operation requires significant specification changes in addition to frequent update of routing tables in the network as the mobile relay moves and hands over. Therefore, this choice is not preferably accepted as the candidate to support mobile relay.

2) The functions of the SGW and PGW for the mobile relay are not transferred and still reside at the base station (e.g. base station 110) to which the mobile relay firstly connects.

This choice is logically similar to option 2 described below for the location of the functions of the SGW and PGW for the mobile relay.

Option 2: the functions of the SGW and PGW for the mobile relay are logically separated from the DeNB. In this option 2, the DeNB is not logically embedded with the SGW and PGW functions for the mobile relay, but connects the SGW and PGW for the mobile relay via S1 interface. In this case, the issues mentioned in choice 1) of option 1 will not occur.

Therefore, in the embodiments of the present invention as described below, the functions of the PGW and SGW for the mobile relay are logically separated from the DeNB for the mobile relay.

Based on the above analysis, if a fixed relay and a mobile relay coexist, it can be clearly observed that during the SGW and PGW selection phase, a mobility management entity MME has to select the SGW and PGW co-located with the DeNB for a fixed relay whereas to select the SGW and PGW logically separated from the DeNB for a mobile relay. Therefore, there is a need to identify the relay identity so as to perform accordingly.

In addition, the MME supporting a mobile relay has different functionalities from the MME supporting a fixed relay. One of the distinct differences is that the mobility related functionalities are not required for the MME supporting a fixed relay whereas are necessary for the MME supporting a mobile relay.

In addition, not all MMEs shall support a relay. Further, not all MMEs supporting a relay shall support a mobile relay and a fixed relay simultaneously, since the MME supporting a mobile relay and the MME supporting a fixed relay have different functionalities.

Without loss of generality, in the embodiments of the present invention as described below, it is assumed that some MMEs support a fixed relay and some MMEs support a mobile relay.

Therefore, the DeNB is required to select an appropriate MME during the MME selection phase, that is, to select a MME supporting a fixed relay, for the fixed relay and to select a MME supporting a mobile relay, for the mobile relay.

FIG. 2 illustrates a wireless communication system in which embodiments of the present invention can be carried out.

As illustrated in FIG. 2, the wireless communication system comprises a mobile relay 210-1, a fixed relay 210-2, a base station 220 (hereinafter also referred to as “DeNB”), MMEs 230-1, 230-2, . . . , 230-N, and SGWs/PGWs 240-1, 240-2, wherein some of the MMEs 230-1, 230-2, . . . , 230-N support a fixed relay and some support a mobile relay. Without loss of generality, it is assumed that MME 230-1 supports a fixed relay while MME 230-2 supports a mobile relay. In addition, the SGW/PGW 240-1 is located within the DeNB 220 and is for a fixed relay, while the SGW/PGW 240-2 is logically separated from the DeNB 220 and is for a mobile relay.

According to embodiments of the present invention, in order to support coexistence of a mobile relay and a fixed relay within the coverage of the DeNB, an explicit mechanism is introduced to differentiate relay identity. Specifically, when a mobile relay attaches to the target DeNB, it shall send a message capable of determining that it is a mobile relay to the DeNB to notify its identity. On the contrary, when a fixed relay attaches to the DeNB, it shall send a message capable of determining that it is a fixed relay to its DeNB.

Based on this message, the DeNB can identify the relay identity and perform accordingly based on the relay identity.

For example, for a mobile relay, during the procedure of the mobile relay attaching to the target DeNB, the DeNB shall not send the gateway transport layer address of itself to the MME since the SGW and PGW for the mobile relay are logically separated from the DeNB.

For a fixed relay, during the procedure of the fixed relay attaching to the DeNB, the DeNB shall send the gateway transport layer address (i.e. IP address) of itself to the MME for the MME to perform the SGW and PGW selection.

In addition, based on the message capable of determining whether a relay is a mobile relay or a fixed relay, the DeNB shall perform a relay related connection reconfiguration, e.g., a relay subframe configuration for the backhaul link.

The DeNB sends the MME an indicator specifically indicating whether the attached relay is a mobile relay or a fixed relay so that the MME could select corresponding SGW and PGW for the relay as described below.

In addition, as described above, in the embodiments of the present invention, only some MMEs support a mobile relay while some MMEs support a fixed relay. Thus, it becomes necessary for the DeNB to select an appropriate MME during the relay attachment procedure. In an embodiment of the present invention, an explicit mechanism is introduced so that MME indicates the supported relay type to the DeNB over S1 interface. Specifically, a MME supporting a mobile relay shall send the DeNB a message that can be used to determine that it supports a mobile relay, while a MME supporting a fixed relay shall send the DeNB a message that can be used to determine that it supports a fixed relay. Based on this message, the DeNB can identify the MME identity and select appropriate MMEs for a mobile relay and a fixed relay, respectively.

The attachment procedure for a fixed relay or a mobile relay consists of two phases: phase I as a UE and phase II for a relay.

In phase I, the relay attaches to the network as a UE and shall not include any relay information. The DeNB treats the relay as a normal UE to perform MME selection. The procedure in phase I can be referred to 3GPP TS 23.401 and is not given here.

In phase II, the relay shall send the DeNB a message that can be used to determine whether the relay is a mobile relay or a fixed relay.

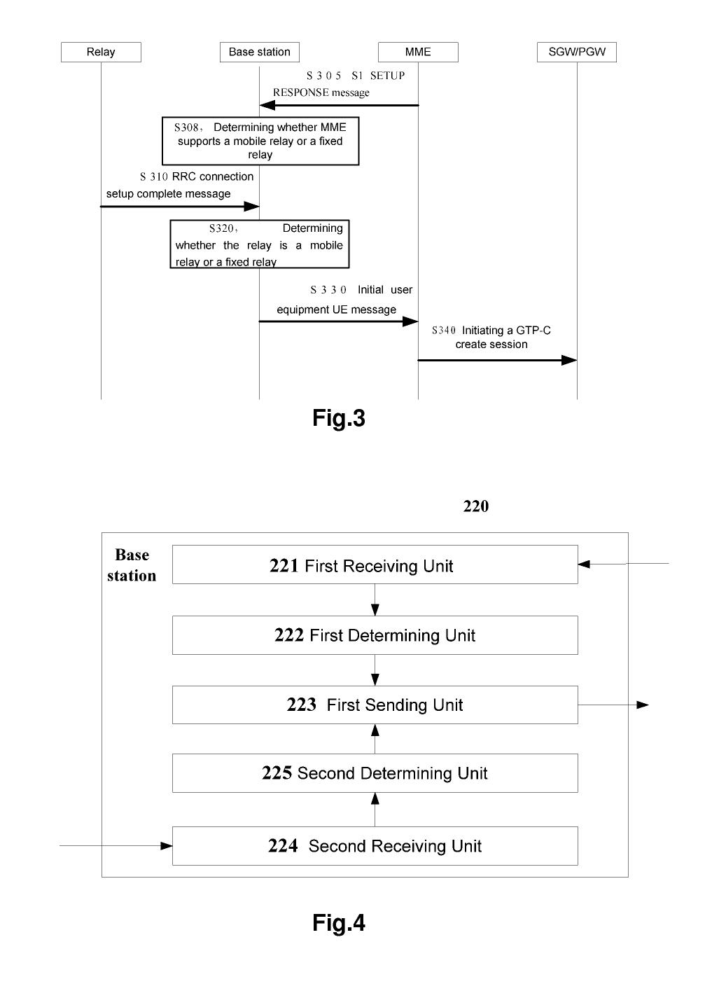

FIG. 3 illustrates a signal flow diagram 300 between respective devices as illustrated in FIG. 2 in phase II.

Firstly, in Step S310, relay 210-1 or relay 210-2 sends a first message to base station 220 that may determine whether the relay is a mobile relay or a fixed relay based on the first message received from the relay.

For example, the first message is a radio resource control RRC connection setup complete message.

The RRC connection setup complete message is illustrated below:

RRCConnectionSetupComplete ::= SEQUENCE {

| | |
|---|---|
| ..... | |
| rn-SubframeConfigReq-r10 | ENUMERATED {required, |
| | notRequired} |
| OPTIONAL, | |
| Mobile-RN-type | ENUMERATED {true} OPTIONAL, |
| } | |

Within the RRC connection setup complete message, a “Mobile-RN-type” field is introduced as indicated by the italics portion. If the “Mobile-RN-type” field presents, it indicates that the connection setup is for a mobile relay. If the “Mobile-RN-type” field does not present, it indicates that the connection setup is for a fixed relay.

Note that the rn-SubframeConfigReq has been defined for a fixed relay to request a relay subframe configuration.

Then, in Step S320, the DeNB 220 determines whether the relay is a mobile relay or a fixed relay based on the first message received from the relay.

Next, in Step S330, the DeNB 220 sends a second message to one of mobility management entities 230-1, 230-2, . . . , 230-N, the second message comprising information indicating whether the relay is a mobile relay or a fixed relay so that the mobility management entity can select a corresponding service gateway SGW and a corresponding packet data network gateway PGW for the relay.

In one embodiment of the present invention, if the relay is a mobile relay, the second message sent to the mobility management entity does not comprise a gateway transport layer address of the base station; whereas if the relay is a fixed relay, the second message sent to the mobility management entity comprises a gateway transport layer address of the base station.

For example, the second message is an initial user equipment UE message, and it includes the following information element for indicating whether the attached relay is a mobile relay or a fixed relay:

| Information | | | | |
|---|---|---|---|---|
| Element/ | | | Information Element | Semantics |
| Group Name | Presence | Range | Type and Reference | Description |
| Relay Indicator | Must | | Enumerated (fixed | |
| | | | relay, mobile | |
| | | | relay, . . . ) | |

Then, in Step S340, the MME selects the SGW and PGW for the relay based on the normal SGW and PGW selection procedure, and initiates a CPRS Tunnel Protocol-Control Plane (GTP-C) create session to the selected SGW and PGW.

If the relay is a mobile relay, the mobility management entity MME selects the SGW and PGW 240-2 that are logically separated from the base station 220, for the relay; if the relay is a fixed relay, the mobility management entity MME selects the SGW and PGW 240-1 that coexist with the base station 220, for the relay.

In an embodiment according to the present invention, the signal flow diagram 300 further comprises Step S305, in which the base station 220 receives a third message from a mobility management entity, and Step S308, in which the base station 220 determines whether the mobility management entity is a mobility management entity supporting a mobile relay or a mobility entity supporting a fixed relay based on the third message received from the mobility management entity.

In addition, in Step S330, if the relay is a mobile relay, the second message is sent to the mobility management entity 230-2 supporting a mobile relay; whereas if the relay is a fixed relay, the second message is sent to the mobility management entity 230-1 supporting a fixed relay.

In one embodiment of the present invention, the third message is an S1 SETUP RESPONSE message and includes the following information element for indicating whether corresponding MME supports a mobile relay or a fixed relay:

| Information | | | | |
|---|---|---|---|---|
| Element/ | | | Information Element | Semantics |
| Group Name | Presence | Range | Type and Reference | Description |
| MME Relay | Must | | Enumerated (fixed | |
| Support | | | relay, mobile | |
| Indicator | | | relay, . . . ) | |

It should be understood by those skilled in the art that the signal flow diagram 300 may further comprise other steps, but these other steps are irrelevant to the preset invention and thus their descriptions are omitted here.

FIG. 4 illustrates a block diagram of base station 220 for supporting coexistence of a mobile relay and a fixed relay in a wireless communication network according to one embodiment of the present invention.

As illustrated in FIG. 4, the base station 220 comprises: a first receiving unit 221 configured to receive a first message from a relay; a first determining unit 222 configured to determine whether the relay is a mobile relay or a fixed relay based on the first message received from the relay; and a first sending unit 223 configured to send a second message to a mobility management entity, the second message comprising information indicating whether the relay is a mobile relay or a fixed relay so that the mobility management entity can select a corresponding service gateway SGW and a corresponding packet data network gateway PGW for the relay.

Wherein if the relay is a mobile relay, the mobility management entity selects a service gateway SGW and a packet data network gateway PGW that are logically separated from the base station, for the relay; and if the relay is a fixed relay, the mobility management entity selects a service gateway SGW and a packet data network gateway PGW that coexist with the base station, for the relay.

In one embodiment of the present invention, the first message is a radio resource control RRC connection setup complete message, and the second message is an initial user equipment UE message.

In one embodiment of the present invention, the base station 220 further comprises: a second receiving unit 224 configured to receive a third message from the mobility management entity; a second determining unit 225 configured to determine whether the mobility management entity is a mobility management entity supporting a mobile relay or a mobility management entity supporting a fixed relay, based on the third message received from the mobility management entity.

Wherein if the relay is a mobile relay, the first sending unit 223 sends the second message to a mobility management entity supporting a mobile relay; and if the relay is a fixed relay, the first sending unit 223 sends the second message to a mobility management entity supporting a fixed relay.

In one embodiment of the present invention, the third message is an S1 SETUP RESPONSE message.

In one embodiment of the present invention, if the relay is a mobile relay, the second message sent by the first sending unit 223 to the mobility management entity does not comprise a gateway transport layer address of the base station 220; and if the relay is a fixed relay, the second message sent by the first sending unit 223 to the mobility management entity comprises a gateway transport layer address of the base station 220.

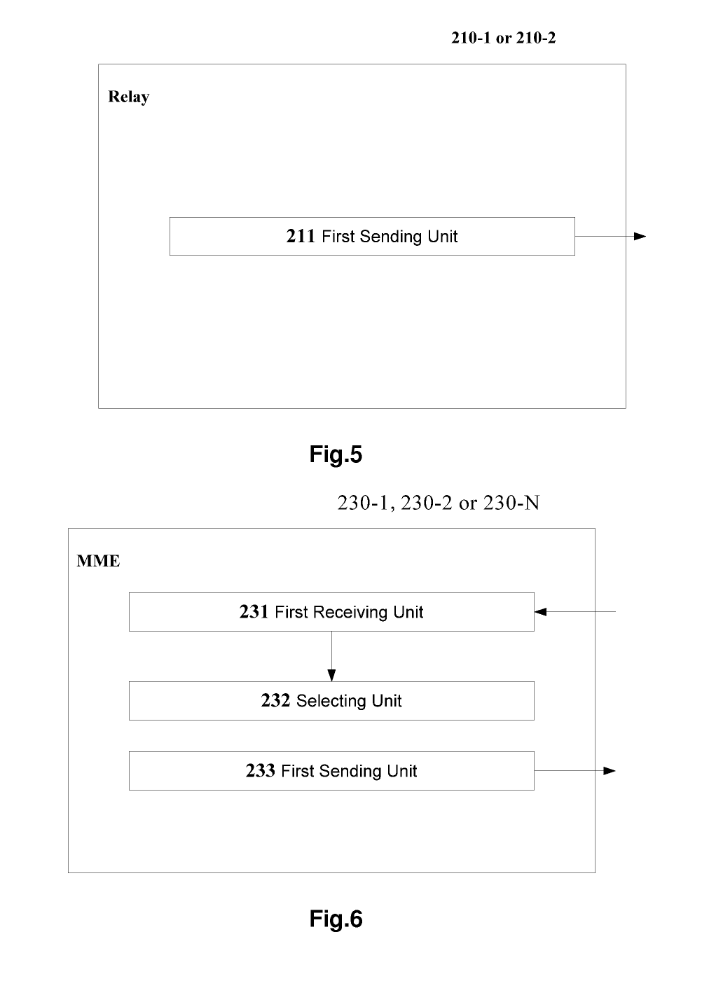

FIG. 5 illustrates a block diagram of relay 210-1 or 210-2 for supporting coexistence of a mobile relay and a fixed relay in a wireless communication network according to an embodiment of the present invention.

As illustrated in FIG. 5, the relay comprises: a first sending unit 211 configured to send a first message to a base station 220 that may determine whether the relay is a mobile relay or a fixed relay based on the first message sent from the first sending unit 211.

FIG. 6 illustrates a block diagram of mobility management entity 230-1, 230-2, . . . , or 230-N for supporting coexistence of a mobile relay and a fixed relay in a wireless communication network according to an embodiment of the present invention.

As illustrated in FIG. 6, the mobility management entity MME comprise: a first receiving unit 231 configured to receive a second message from a base station 220, the second message comprising information indicating whether a relay is a mobile relay or a fixed relay so that the MME can select a corresponding service gateway SGW and a corresponding packet data network gateway PGW for the relay; and a selecting unit 232 configured to select a SGW and a PGW for the relay based on the second message.

If the relay is a mobile relay, the mobility management entity selects a service gateway SGW and a packet data network gateway PGW that are logically separated from the base station, for the relay; and if the relay is a fixed relay, the mobility management entity selects a service gateway SGW and a packet data network gateway PGW that coexist with the base station, for the relay.

According to one embodiment of the present invention, the MME further comprises: a first sending unit 233 configured to send a third message to the base station 220 that may determine whether the MME is a mobility management entity supporting a mobile relay or a mobility management entity supporting a fixed relay, based on the third message sent by the first sending unit 233. And the second message is sent to a MME supporting a mobile relay if the relay is a mobile relay, or the second message is sent to a MME supporting a fixed relay if the relay is a fixed relay.

According to one embodiment of the present invention, if the relay is a mobile relay, the second message received from the base station 220 does not comprise a gateway transport layer address of the base station 220; and if the relay is a fixed relay, the second message received from the base station 220 comprises a gateway transport layer address of the base station 220.

It should be noted that in order to make the present invention easier to understand, some more specific technical details that are well-known to those skilled in the art and may be essential for implementation of the present invention are omitted in the above descriptions.

Those skilled in the art should also understand that the present invention is not limited to the above-described steps and it further covers the combination, order change, etc., of the above-described steps. The final scope of the present invention is defined by the appended claims.

Hence, selecting and describing the embodiments is to better explain the principle of the present invention and its actual application, and to make it clear for those of ordinary skill in the art that without departure from the essence of the present invention, all modifications and changes fall within the protection scope of the present invention defined by claims.

1. A method for supporting coexistence of a mobile relay and a fixed relay in a wireless communication network, comprising:
receiving, by a base station, a first message from a relay;
determining, by the base station, whether the relay is a mobile relay or a fixed relay based on the first message received from the relay;
sending, by the base station, a second message to a mobility management entity, the second message comprising information indicating whether the relay is a mobile relay or a fixed relay so that the mobility management entity can select a corresponding service gateway SGW and a corresponding packet data network gateway PGW for the relay.

2. The method according to claim 1, further comprising:
receiving, by the base station, a third message from the mobility management entity;
determining, by the base station, whether the mobility management entity is a mobility management entity supporting a mobile relay or a mobility management entity supporting a fixed relay, based on the third message received from the mobility management entity; and
the second message is sent to a mobility management entity supporting a mobile relay if the relay is a mobile relay, and the second message is sent to a mobility management entity supporting a fixed relay if the relay is a fixed relay.

3. The method according to claim 1, wherein if the relay is a mobile relay, the second message sent to the mobility management entity does not comprise a gateway transport layer address of the base station; and if the relay is a fixed relay, the second message sent to the mobility management entity comprises a gateway transport layer address of the base station.

4. The method according to claim 1, wherein if the relay is a mobile relay, the mobility management entity selects a service gateway SGW and a packet data network gateway PGW that are logically separated from the base station, for the relay; and if the relay is a fixed relay, the mobility management entity selects a service gateway SGW and a packet data network gateway PGW that coexist with the base station, for the relay.

5. A base station for supporting coexistence of a mobile relay and a fixed relay in a wireless communication network, comprising:
a first receiving unit configured to receive a first message from a relay;
a first determining unit configured to determine whether the relay is a mobile relay or a fixed relay based on the first message received from the relay;
a first sending unit configured to send a second message to a mobility management entity, the second message comprising information indicating whether the relay is a mobile relay or a fixed relay so that the mobility management entity can select a corresponding service gateway SGW and a corresponding packet data network gateway PGW for the relay.

6. The base station according to claim 5, further comprising:
a second receiving unit configured to receive a third message from the mobility management entity;
a second determining unit configured to determine whether the mobility management entity is a mobility management entity supporting a mobile relay or a mobility management entity supporting a fixed relay, based on the third message received from the mobility management entity; and
the first sending unit sends the second message to a mobility management entity supporting a mobile relay if the relay is a mobile relay, and the first sending unit sends the second message to a mobility management entity supporting a fixed relay if the relay is a fixed relay.

7. The base station according to claim 5, wherein if the relay is a mobile relay, the second message sent by the first sending unit to the mobility management entity does not comprise a gateway transport layer address of the base station; and if the relay is a fixed relay, the second message sent by the first sending unit to the mobility management entity comprises a gateway transport layer address of the base station.

8. The base station according to claim 5, wherein if the relay is a mobile relay, the mobility management entity selects a service gateway SGW and a packet data network gateway PGW that are logically separated from the base station, for the relay; and if the relay is a fixed relay, the mobility management entity selects a service gateway SGW and a packet data network gateway PGW that coexist with the base station, for the relay.

9. A method for supporting coexistence of a mobile relay and a fixed relay in a wireless communication network, comprising:
sending, by a relay, a first message to a base station that may determine whether the relay is a mobile relay or a fixed relay based on the first message received from the relay.

10. A relay for supporting coexistence of a mobile relay and a fixed relay in a wireless communication network, comprising:
a first sending unit configured to send a first message to a base station that may determine whether the relay is a mobile relay or a fixed relay based on the first message sent from the first sending unit.

11. A method for supporting coexistence of a mobile relay and a fixed relay in a wireless communication network, comprising:
receiving, by a mobility management entity, a second message from a base station, the second message comprising information indicating whether a relay is a mobile relay or a fixed relay so that the mobility management entity can select a corresponding service gateway SGW and a corresponding packet data network gateway PGW for the relay; and
selecting, by the mobility management entity, a SGW and PGW for the relay based on the second message;
wherein if the relay is a mobile relay, the mobility management entity selects a service gateway SGW and a packet data network gateway PGW that are logically separated from the base station, for the relay; and if the relay is a fixed relay, the mobility management entity selects a service gateway SGW and a packet data network gateway PGW that coexist with the base station, for the relay.

12. The method according to claim 11, further comprising:
sending, by the mobility management entity, a third message to the base station that may determine whether the mobility management entity is a mobility management entity supporting a mobile relay or a mobility management entity supporting a fixed relay, based on the third message sent from the mobility management entity; and
the second message is sent to a mobility management entity supporting a mobile relay if the relay is a mobile relay, and the second message is sent to a mobility management entity supporting a fixed relay if the relay is a fixed relay.

13. The method according to claim 11, wherein if the relay is a mobile relay, the second message received from the base station does not comprise a gateway transport layer address of the base station; and if the relay is a fixed relay, the second message received from the base station comprises a gateway transport layer address of the base station.

14. A mobility management entity for supporting coexistence of a mobile relay and a fixed relay in a wireless communication network, comprising:
a first receiving unit configured to receive a second message from a base station, the second message comprising information indicating whether a relay is a mobile relay or a fixed relay so that the mobility management entity can select a corresponding service gateway SGW and a corresponding packet data network gateway PGW for the relay; and
a selecting unit configured to select a SGW and a PGW for the relay based on the second message;
wherein if the relay is a mobile relay, the mobility management entity selects a service gateway SGW and a packet data network gateway PGW that are logically separated from the base station, for the relay; and if the relay is a fixed relay, the mobility management entity selects a service gateway SGW and a packet data network gateway PGW that coexist with the base station, for the relay.

15. The mobility management entity according to claim 14, further comprising:
a first sending unit configured to send a third message to the base station that may determine whether the mobility management entity is a mobility management entity supporting a mobile relay or a mobility management entity supporting a fixed relay, based on the third message sent by the first sending unit; and
the second message is sent to a mobility management entity supporting a mobile relay if the relay is a mobile relay, and the second message is sent to a mobility management entity supporting a fixed relay if the relay is a fixed relay, and
wherein if the relay is a mobile relay, the second message received from the base station does not comprise a gateway transport layer address of the base station; and if the relay is a fixed relay, the second message received from the base station comprises a gateway transport layer address of the base station.

16. (canceled)
